(19) United States
(12) Patent Application Publication
(10) Pub. No.: US 2026/0329205 A1
(43) Pub. Date: Oct. 22, 2026

(54) DEVELOPING ROLLER, DEVELOPING DEVICE, AND IMAGE FORMING APPARATUS

(71) Applicant: KYOCERA Document Solutions Inc., Osaka (JP)

(72) Inventors: Kazuaki EZURE, Osaka (JP); Yukimasa WATANABE, Osaka (JP)

(73) Assignee: KYOCERA Document Solutions Inc., Osaka (JP)

(21) Appl. No.: 19/652,565

(22) Filed: Apr. 20, 2026

(30) Foreign Application Priority Data
Apr. 22, 2025 (JP) 2025-070517

(51) Int. Cl. G03G 15/09; H01F 1/055; H01F 7/02

(52) U.S. Cl. CPC G03G 15/0928; H01F 7/0205; H01F 1/0551

(57) ABSTRACT

A developing roller includes a shaft, a plurality of magnets, and a developing sleeve. The plurality of magnets include a reference magnet that is fixed first at a reference point along the circumferential direction of the shaft. The developing roller further has a protrusion and a depression. The protrusion is formed on one of the outer circumferential surface of the shaft and the inner circumferential surface of the reference magnet, extends along the axial direction, and protrudes radially toward the other. The depression is formed in the other of the outer circumferential surface of the shaft and the inner circumferential surface of the reference magnet, extends along the axial direction, and is depressed radially into that outer or inner circumferential surface. The protrusion is inserted in the depression.

### INCORPORATION BY REFERENCE

This application is based on and claims the benefit of priority from Japanese Patent Application No. 2025-070517 filed on Apr. 22, 2025, the contents of which are hereby incorporated by reference.

### BACKGROUND

The present disclosure relates to a developing roller, a developing device, and an image forming apparatus.

In an electrophotographic image forming apparatus such as a copier and a printer, a developing device is widely used that feeds toner to an electrostatic latent image formed on the outer circumferential surface of an image carrying member, such as a photosensitive drum, to develop it and thereby form a toner image that is later transferred to a sheet (recording medium). The developing device includes a developing roller that carries on its outer circumferential surface developer containing toner stored in a developing container and that feeds it to the photosensitive drum.

### SUMMARY

According to one aspect of the present disclosure, a developing roller includes a shaft, a plurality of magnets, and a developing sleeve. The plurality of magnets are fixed to the outer circumferential surface of the shaft and extend along the axial direction of the shaft. The developing sleeve is disposed to face the radially outer side of the magnet across a predetermined gap. The plurality of magnets include a reference magnet that is fixed first at a reference point along the circumferential direction of the shaft. The developing roller further has a protrusion and a depression. The protrusion is formed on one of the outer circumferential surface of the shaft and the inner circumferential surface of the reference magnet, extends along the axial direction, and protrudes radially toward the other. The depression is formed in the other of the outer circumferential surface of the shaft and the inner circumferential surface of the reference magnet, extends along the axial direction, and is depressed radially into that outer or inner circumferential surface. The protrusion is inserted in the depression

### BRIEF DESCRIPTION OF THE DRAWINGS

FIG. 1 is a schematic sectional front view of an image forming apparatus of an embodiment of the present disclosure.

FIG. 2 is a schematic sectional front view around an image forming portion in the image forming apparatus in FIG. 1.

FIG. 3 is an enlarged view around a developing roller in the developing device in the image forming portion in FIG. 2.

FIG. 4 is an illustrative diagram showing a first stage of an assembly procedure for the developing roller in FIG. 3.

FIG. 5 is an illustrative diagram showing a second stage of an assembly procedure for the developing roller in FIG. 3.

FIG. 6 is a perspective view showing a state in which a reference magnet is attached to a shaft of the developing roller in FIG. 3.

FIG. 7 is a sectional view of the shaft of the developing roller in FIG. 6 and the reference magnet.

FIG. 8 is a sectional view showing a state in which a second magnet is attached to the shaft of the developing roller in FIG. 7 and to the reference magnet.

FIG. 9 is a sectional view of a shaft and a reference magnet of a developing roller of Modified Example 1.

FIG. 10 is a sectional view of a shaft and a reference magnet of a developing roller of Modified Example 2.

FIG. 11 is a sectional view of a shaft and a reference magnet of a developing roller of Modified Example 3.

FIG. 12 is a sectional view of a shaft and a reference magnet of a developing roller of Comparative Example 2.

FIG. 13 is a sectional view of a shaft and a reference magnet of a developing roller of Comparative Example 3.

FIG. 14 is a sectional view of a shaft and a reference magnet of a developing roller of Comparative Example 5.

FIG. 15 is a sectional view of a shaft and a reference magnet of a developing roller of Comparative Example 6.

### DETAILED DESCRIPTION

An embodiment of the present disclosure will be described below with reference to the accompanying drawings. The embodiment described below is not meant to limit the scope of the present disclosure.

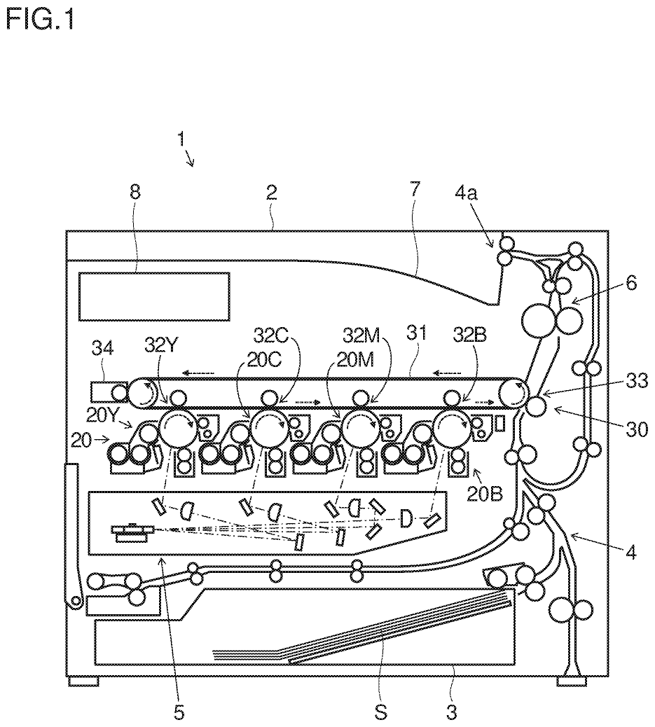

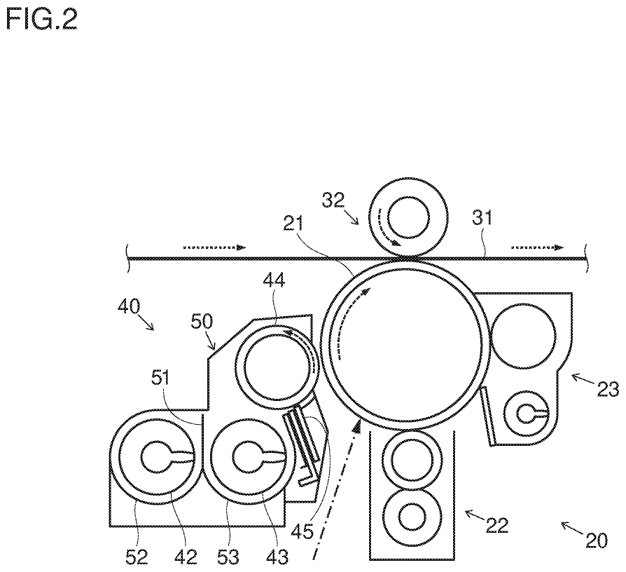

FIG. 1 is a schematic sectional front view of an image forming apparatus 1 of the embodiment. FIG. 2 is a schematic sectional front view around an image forming portion 20 in the image forming apparatus 1 in FIG. 1. One example of the image forming apparatus 1 of the embodiment is a tandem-type color printer that transfers a toner image to a sheet S using an intermediate transfer belt 31. The image forming apparatus 1 may be what is called a multifunction peripheral that has the functions of printing, scanning (image reading), facsimile transmission, and the like.

As shown in FIGS. 1 and 2, the image forming apparatus 1 includes, provided in a body 2 of it, a sheet feed portion 3, a sheet conveying portion 4, an exposure portion 5, an image forming portion 20, a transfer portion 30, a fixing portion 6, a sheet discharge portion 7, and a control portion 8.

The sheet feed portion 3 is disposed in a bottom part of the body 2. The sheet feed portion 3 stores a plurality of unprinted sheets S and separates and feeds them out one sheet S at a time during printing. The sheet conveying portion 4 extends vertically along a side wall of the body 2. The sheet conveying portion 4 conveys the sheet S fed out from the sheet feed portion 3 to a secondary transfer portion 33 and the fixing portion 6 and then discharges the fixed sheet S through a sheet discharge port 4a to the sheet discharge portion 7.

The exposure portion 5 is disposed above the sheet feed portion 3. The exposure portion 5 shines laser light controlled based on image data to the image forming portion 20.

The image forming portion 20 is disposed above the exposure portion 5, below the intermediate transfer belt 31. The image forming portion 20 comprises a yellow image forming portion 20Y, a cyan image forming portion 20C, a magenta image forming portion 20M, and a black image forming portion 20B. These four image forming portions 20 share the same basic configuration. Accordingly, the suffixes “Y”, “C”, “M”, and “B” for the different colors may be omitted unless distinction is necessary in the following descriptions.

The image forming portion 20 includes a photosensitive drum (image carrying member) 21 supported so as to be rotatable in a predetermined direction (clockwise in FIGS. 1 and 2). The image forming portion 20 further includes a charging portion 22, a developing device 40, and a drum cleaning portion 23 disposed around the photosensitive drum 21 along its rotational direction. A primary transfer portion 32 is disposed between the developing device 40 and the drum cleaning portion 23.

The photosensitive drum 21 is formed in a cylindrical shape extending in a horizontal direction and has on its outer circumferential surface a photosensitive layer formed of, for example, an amorphous silicon photosensitive member. The charging portion 22 electrostatically charges the surface (outer circumferential surface) of the photosensitive drum 21 to a predetermined potential. The exposure portion 5 exposes to light the outer circumferential surface of the photosensitive drum 21 electrostatically charged by the charging portion 22, to form on it an electrostatic latent image based on a document image. The developing device 40 feeds toner to the electrostatic latent image to develop it into a toner image. The four image forming portions 20 each form a toner image of a different color. After the toner image is primarily transferred to the outer circumferential surface of the intermediate transfer belt 31, the drum cleaning portion 23 cleans the photosensitive drum 21 by removing the toner and the like remaining on its outer circumferential surface. In this way, the image forming portion 20 forms the image (toner image) to be transferred to the sheet S later.

The transfer portion 30 includes the intermediate transfer belt 31, the primary transfer portions 32Y, 32C, 32M, and 32B, the secondary transfer portion 33, and a belt cleaning portion 34. The intermediate transfer belt 31 is disposed above the four image forming portions 20. The intermediate transfer belt 31 is an endless intermediate transfer member that is supported so as to be rotatable in a predetermined direction (counterclockwise in FIG. 1) and to which the toner images formed respectively in the four image forming portions 20 are primarily transferred so as to be sequentially superimposed on each other. The four image forming portions 20 are disposed in what is called a tandem configuration by being aligned in a row from upstream to downstream along the rotational direction of the intermediate transfer belt 31.

The primary transfer portions 32Y, 32C, 32M, and 32B are disposed above the image forming portions of the different colors 20Y, 20C, 20M, and 20B across the intermediate transfer belt 31. The secondary transfer portion 33 is disposed upstream of the fixing portion 6 with respect to the sheet conveying direction in the sheet conveying portion 4, downstream of the four image forming portions 20Y, 20C, 20M, and 20B with respect to the rotational direction of the intermediate transfer belt 31. The belt cleaning portion 34 is disposed downstream of the secondary transfer portion 33 with respect to the rotational direction of the intermediate transfer belt 31.

The primary transfer portion 32 transfers the toner image formed on the outer circumferential surface of the photosensitive drum 21 to the intermediate transfer belt 31. In other words, the toner image is primarily transferred to the outer circumferential surface of the intermediate transfer belt 31 by the primary transfer portions 32Y, 32C, 32M, and 32B of the different colors. As the intermediate transfer belt 31 rotates, the toner images from the four image forming portions 20 are transferred to the intermediate transfer belt 31 with predetermined timing so as to be sequentially superimposed on each other. As a result, a color toner image resulting from the toner images of the four colors of yellow, cyan, magenta, and black being superimposed on each other is formed on the outer circumferential surface of the intermediate transfer belt 31.

The color toner image on the outer circumferential surface of the intermediate transfer belt 31 is transferred to the sheet S synchronously conveyed by the sheet conveying portion 4, at a secondary transfer nip portion formed in the secondary transfer portion 33. The belt cleaning portion 34 cleans the outer circumferential surface of the intermediate transfer belt 31 by removing the toner and the like left on it after secondary transfer. In this way, the transfer portion 30 transfers (records) the toner image formed on the outer circumferential surface of the photosensitive drum 21 to the sheet S.

The fixing portion 6 is disposed above the secondary transfer portion 33. The fixing portion 6 fixes the toner image to the sheet S by heating and pressing the sheet S having the toner image transferred to it.

The sheet discharge portion 7 is disposed above the transfer portion 30. The sheet S having the toner image fixed to it and having completed printing is conveyed to the sheet discharge portion 7. The sheet discharge portion 7 allows the printed sheet (print result) to be retrieved from above.

The control portion 8 includes a CPU, an image processing portion, a storage portion, and other electronic circuits and components (of which none is illustrated). Based on control program and data stored in the storage portion, the CPU controls the operation of different parts of the image forming apparatus 1 to perform processes related to the functions of the image forming apparatus 1. The sheet feed portion 3, the sheet conveying portion 4, the exposure portion 5, the image forming portion 20, the transfer portion 30, and the fixing portion 6 individually receive commands from the control portion 8 and operate in coordination to perform printing on the sheet S. The storage portion is configured, for example, as a combination of a non-volatile storage device such as a program ROM (read-only memory) and a data ROM, and a volatile storage device, such as a RAM (random-access memory).

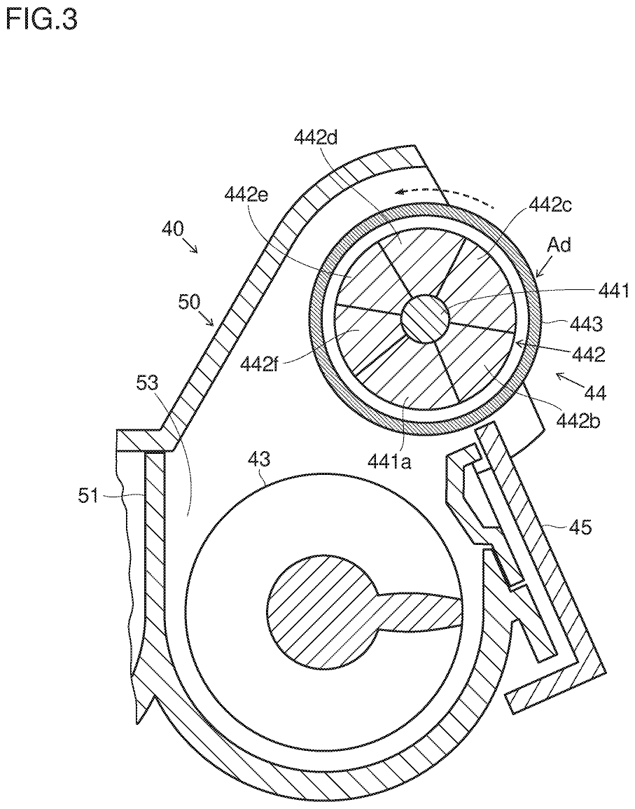

Next, the configuration of the developing device 40 will be described with reference to FIG. 3 in addition to FIG. 2. FIG. 3 is an enlarged view around a developing roller in the developing device in the image forming portion in FIG. 2. Since developing devices 40 for different colors have the same basic configuration, for their components, no suffixes for different colors are used and no overlapping description is repeated. In the following description, the “axial direction” refers to the direction of the rotation axes of the photosensitive drum 21, a first conveying member 42, a second conveying member 43, and a developing roller 44, which extend parallel to one another (i.e., the direction into the plane of FIGS. 2 and 3).

The developing device 40 feeds toner to the outer circumferential surface of the photosensitive drum 21. The developing device 40 is removably mounted, for example, in the body 2 of the image forming apparatus 1. As shown in FIGS. 2 and 3, the developing device 40 includes a developing container 50, the first and second conveying members 42 and 43, the developing roller (developer carrying member) 44, and a regulating member 45.

The developing container 50 has an elongate shape extending along the axial direction of the photosensitive drum 21 and is disposed with its longitudinal direction horizontal. That is, the longitudinal direction of the developing container 50 is parallel to the axial direction of the photosensitive drum 21. The developing container 50 stores, as developer containing toner to be fed to the photosensitive drum 21, for example, two-component developer containing toner and magnetic carrier.

The developing container 50 has a partition portion 51, a first conveying chamber 52, and a second conveying chamber 53.

The partition portion 51 is provided in a lower part in the developing container 50. The partition portion 51 is disposed substantially in a middle part of the developing container 50 along a direction intersecting its longitudinal direction (along the left-right, lateral, direction in FIG. 2). The partition portion 51 is formed substantially in a plate shape extending along the longitudinal direction and the top-bottom direction of the developing container 50. The partition portion 51 divides the inside of the developing container 50 in a direction intersecting the longitudinal direction.

The first and second conveying chambers 52 and 53 are provided in the developing container 50. The first and second conveying chambers 52 and 53 are formed by dividing the inside of the developing container 50 with the partition portion 51. The first and second conveying chambers 52 and 53 are disposed side by side at approximately the same height.

The second conveying chamber 53 includes a region in the developing container 50 where the developing roller 44 is disposed, and is disposed adjacent to the photosensitive drum 21. The first conveying chamber 52 is disposed in a region in the developing container 50 farther from the photosensitive drum 21 than the second conveying chamber 53. The first conveying chamber 52 has a developer supply port (not illustrated) and, through it, developer is supplied into the developing container 50.

The developing container 50 also has developer communication portions (not illustrated) disposed outward of opposite end parts, respectively, of the partition portion 51 along its longitudinal direction. The first and second conveying chambers 52 and 53 communicate with each other via the two developer communication portions disposed in their opposite end parts along the longitudinal direction. Developer moves between the first and second conveying chambers 52 and 53 via the two developer communication portions.

The first conveying member 42 is disposed in the first conveying chamber 52. The second conveying member 43 is disposed in the second conveying chamber 53. The first and second conveying members 42 and 43 are disposed side by side at approximately the same height. The second conveying member 43 extends close to and parallel to the developing roller 44. The first and second conveying members 42 and 43 are supported on the developing container 50 so as to be rotatable about axes extending in a horizontal direction parallel to the developing roller 44.

The first and second conveying members 42 and 43 have the same basic configuration. The first and second conveying members 42 and 43 each have a conveying blade formed in a spiral shape on an outer circumferential part of a rotation shaft extending along the longitudinal direction of the developing container 50. The first and second conveying members 42 and 43 rotate about their axes to convey, while stirring, developer in opposite directions along the axial direction (longitudinal direction), and thereby circulate the developer in a predetermined conveying direction.

The developing roller 44 is located above the second conveying member 43 in the developing container 50 and is disposed to face the photosensitive drum 21. The developing roller 44 is supported on the developing container 50 so as to be rotatable about an axis extending parallel to the axis of the photosensitive drum 21.

The developing roller 44 has part of its outer circumferential surface exposed through the developing container 50 to closely face the photosensitive drum 21. In a region Ad where it faces the photosensitive drum 21, the developing roller 44 carries on its outer circumferential surface toner to be fed to the outer circumferential surface of the photosensitive drum 21. The developing roller 44 carries the toner in the second conveying chamber 53 in the developing container 50 to feed it to the photosensitive drum 21. In other words, the developing roller 44 attaches the toner in the second conveying chamber 53 to the electrostatic latent image on the outer circumferential surface of the photosensitive drum 21 to form the toner image.

The regulating member 45 is disposed upstream in the rotational direction of the developing roller 44 relative to the region Ad where the developing roller 44 faces the photosensitive drum 21. The regulating member 45 is disposed to closely face the developing roller 44, with a predetermined gap between its tip end and the outer circumferential surface of the developing roller 44. The regulating member 45 extends over the entire region of the developing roller 44 along its axial direction. The regulating member 45 regulates the layer thickness of the developer carried on the outer circumferential surface of the developing roller 44 while the developer passes through the gap between the tip end of the regulating member 45 and the outer circumferential surface of the developing roller 44.

As the first and second conveying members 42 and 43 rotate, the developer in the developing container 50 circulates between the first and second conveying chambers 52 and 53 in a predetermined direction through the two developer communication portions. Meanwhile, the toner in the developing container 50 is stirred and electrostatically charged to be carried on the outer circumferential surface of the developing roller 44. The developer carried on the outer circumferential surface of the developing roller 44 has its layer thickness regulated by the regulating member 45, and is then conveyed to the region Ad where the developing roller 44 faces the photosensitive drum 21 as the developing roller 44 rotates. When a predetermined development voltage is applied to the developing roller 44, the potential difference from the surface (outer circumferential surface) of the photosensitive drum 21 causes the toner in the developer carried on the outer circumferential surface of the developing roller 44 to move to the outer circumferential surface of the photosensitive drum 21 in the region Ad. As a result, the electrostatic latent image on the outer circumferential surface of the photosensitive drum 21 is developed with the toner.

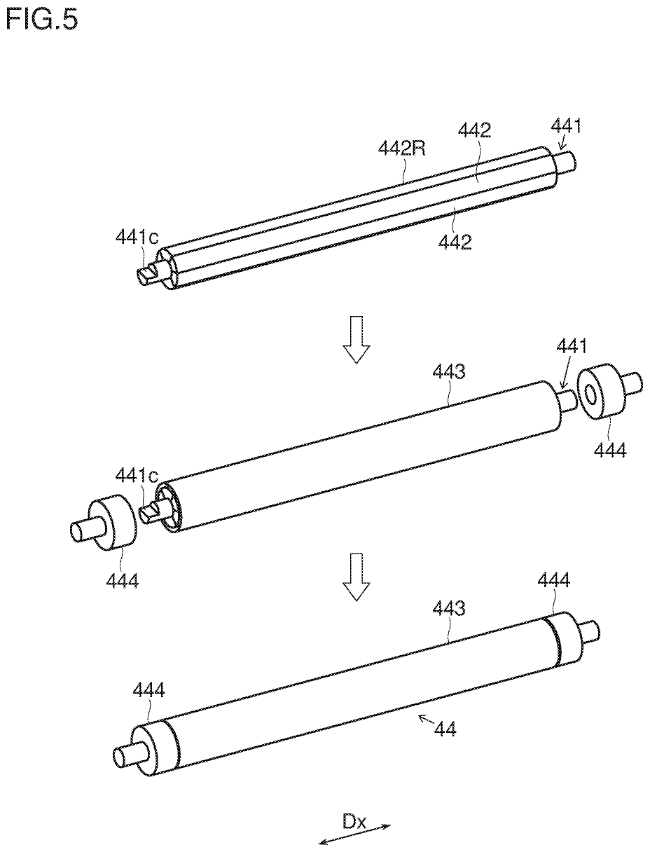

Next, the configuration of the developing roller 44 will be described in detail. The developing roller 44 includes a shaft 441, a plurality of magnets 442, a developing sleeve 443, and a flange member 444 (see FIG. 5).

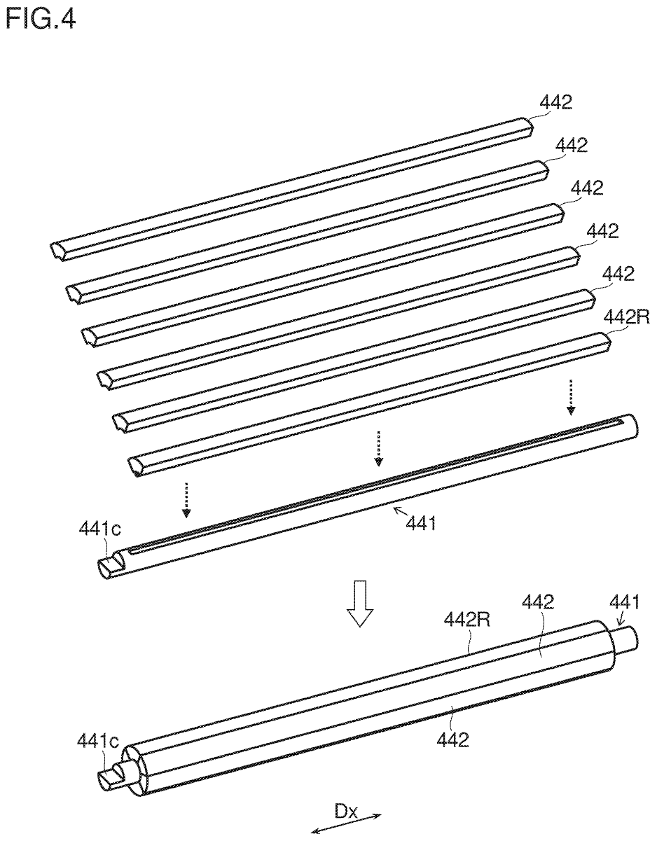

The shaft 441 is formed of a metallic material such as steel, in a cylindrical shape (rod shape), and extends parallel to the axis of the photosensitive drum 21. The shaft 441 is located at the center of the developing roller 44 along the radial direction and extends along the axial direction of the developing roller 44. The shaft 441 has, in one end part of it along the axial direction, a D-cut face 441c (see FIG. 4) with a D-shaped section along the radial direction, and is unrotatably fixed to the developing container 50 via the D-cut face 441c.

The plurality of magnets 442 are disposed side by side along the circumferential direction on the outer circumferential surface of the shaft 441 and are fixed to the outer circumferential surface of the shaft 441. Each of the plurality of magnets 442 has a fan-shaped section along the radial direction and extends along the axial direction of the shaft 441. The length of the magnet 442 along the axial direction is smaller than the length of the shaft 441 along the axial direction. Each of the plurality of magnets 442 is attached and fixed to the outer circumferential surface of the shaft 441, for example, with adhesive.

In the embodiment, six magnets 442 are disposed side by side along the circumferential direction on the outer circumferential surface of the shaft 441. That is, the developing roller 44 has six magnetic poles arranged along the circumferential direction (i.e., the rotational direction of the developing sleeve 443). The six magnetic poles (magnets 442) includes an attracting pole 442a, a regulating pole 442b, a developing pole 442c, a conveying pole 442d, a peeling pole 442e, and a separating pole 442f.

The attracting pole 442a is disposed at a position upstream of the regulating member 45 in the rotational direction of the developing sleeve 443, opposite the second conveying member 43 across the developing sleeve 443. The attracting pole 442a produces a peak magnetic force (magnetic flux density) at a position opposite the second conveying member 43. The magnetic force of the attracting pole 442a attracts the developer conveyed and stirred by the second conveying member 43 to the outer circumferential surface of the developing sleeve 443.

The regulating pole 442b is disposed at a position downstream of the attracting pole 442a in the rotational direction of the developing sleeve 443, opposite the regulating member 45 across the developing sleeve 443. The regulating pole 442b produces a peak magnetic force (magnetic flux density) at a position opposite the regulating member 45. The magnetic force of the regulating pole 442b and the regulating member 45 regulate the layer thickness of the developer carried on the outer circumferential surface of the developing sleeve 443.

The developing pole 442c is disposed downstream of the regulating pole 442b in the rotational direction of the developing sleeve 443 to face the region Ad facing the photosensitive drum 21. The developing pole 442c produces a peak magnetic force (magnetic flux density) in the region Ad facing the photosensitive drum 21. The magnetic force of the developing pole 442c allows the developer to be carried on the outer circumferential surface of the developing sleeve 443, and allows only toner to fly to the photosensitive drum 21 under a developing bias to develop the electrostatic latent image on the surface of the photosensitive drum 21.

The conveying pole 442d is disposed downstream of the developing pole 442c in the rotational direction of the developing sleeve 443. The magnetic force of the conveying pole 442d allows the developer to be carried on the outer circumferential surface of the developing sleeve 443 to be conveyed in the rotational direction as the developing sleeve 443 rotates.

The peeling pole 442e is disposed downstream of the conveying pole 442d in the rotational direction of the developing sleeve 443, upstream of the attracting pole 442a in the rotational direction of the developing sleeve 443. As the developing sleeve 443 rotates, the developer that has reached the peeling pole 442e is released from the outer circumferential surface of the developing sleeve 443 to fall below the second conveying chamber 53.

The separating pole 442f is disposed downstream of the peeling pole 442e in the rotational direction of the developing sleeve 443, between the attracting pole 442a and the peeling pole 442e along the circumferential direction. The magnetic force of the separating pole 442f can prevent the lines of the magnetic force of the peeling pole 442e from reaching the attracting pole 442a.

The developing sleeve 443 is formed of a metallic material such as aluminum, in a cylindrical shape, and extends parallel to the axis of the photosensitive drum 21. The developing sleeve 443 has an opening in each of its opposite end parts along the axial direction. The developing sleeve 443 is disposed to face the radially outer side of the magnet 442 across a predetermined gap. The length of the developing sleeve 443 along the axial direction is approximately equal to the length of the magnet 442 along the axial direction. The developing sleeve 443 is supported on the developing container 50 via the flange member 444 so as to be rotatable about the axis of the shaft 441, and is rotated by a drive mechanism (not illustrated). The developer is carried on the outer circumferential surface of the developing sleeve 443.

The flange member 444 (see FIG. 5) is formed of a metal material such as aluminum, and is fixed to the opening in each of the opposite end parts of the developing sleeve 443 along the axial direction. The flange member 444 in one end part along the axial direction is connected to the drive mechanism (not illustrated). As a result, the flange member 444 is driven by the drive mechanism to rotate about the axis of the shaft 441 together with the developing sleeve 443.

FIGS. 4 and 5 are illustrative diagrams showing a first and a second stage of an assembly procedure for the developing roller 44 in FIG. 3. The direction in which arrow Dx in the figure extends is the axial direction of the shaft 441.

As shown in FIG. 4, each of the plurality (in the embodiment, six) of magnets 442 is attached to the outer circumferential surface of the shaft 441 with adhesive. The plurality of magnets 442 include a reference magnet 442R that is fixed first at a reference point P0 (see FIG. 7) along the circumferential direction of the shaft 441. The reference point P0 along the circumferential direction of the shaft 441 is determined based on, for example, the D-cut face 441c of the shaft 441.

The first reference magnet 442R is attached manually with reference to the D-cut face 441c of the shaft 441. With reference to the first reference magnet 442 R, the second and subsequent magnets 442 are attached manually one adjacent to another along the circumferential direction of the shaft 441. This completes the assembly of a magnetic roller comprising six magnets 442 disposed side by side and fixed to the outer circumferential surface of the shaft 441 along the circumferential direction.

As shown in FIG. 5, the magnetic roller comprising the shaft 441 and the six magnets 442 is inserted into the developing sleeve 443. Then, to the opening in each of the opposite end parts of the developing sleeve 443 along the axial direction, the flange member 444 is fixed with adhesive. The developing sleeve 443 and the two flange members 444 are integrally configured and rotate relative to the magnetic roller comprising the shaft 441 and the six magnets 442.

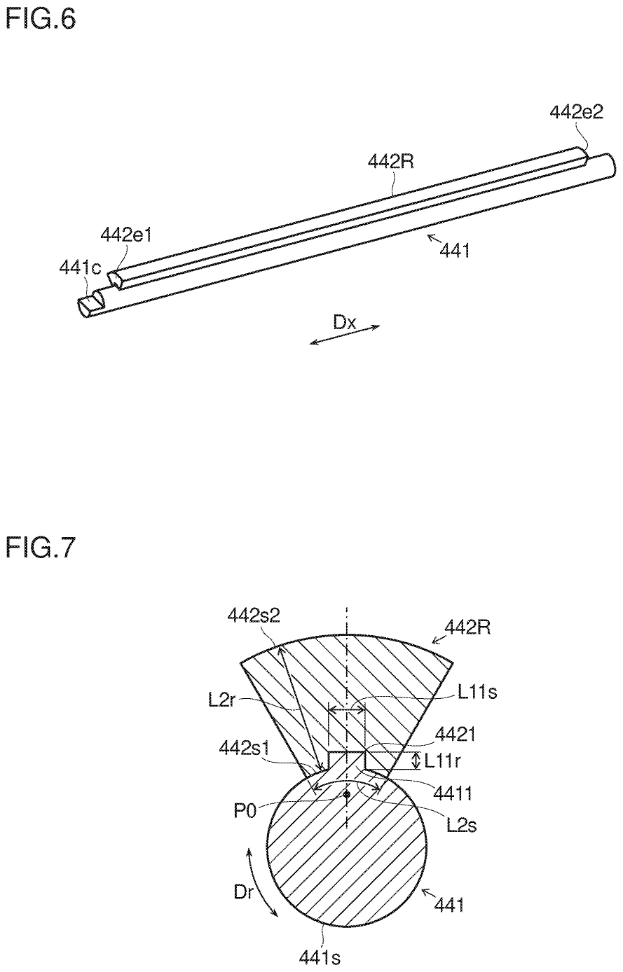

Next, the configuration of the shaft 441 and the reference magnet 442R will be described in detail. FIG. 6 is a perspective view showing a state in which the reference magnet 442R is attached to the shaft 441 of the developing roller 44 in FIG. 3. FIG. 7 is a sectional view of the shaft 441 of the developing roller 44 in FIG. 6 and the reference magnet 442R. FIG. 7 is a sectional view along the radial direction of what is shown in FIG. 6. In FIGS. 6 and 7, the axial direction Dx and the circumferential direction Dr of the shaft 441, respectively, are indicated.

As shown in FIG. 7, the shaft 441 has a protrusion 4411. The reference magnet 442R has a depression 4421.

The protrusion 4411 is formed on the outer circumferential surface 441s of the shaft 441 and extends along the axial direction Dx of the shaft 441. Specifically, the protrusion 4411 is positioned along the circumferential direction Dr based on the reference point P0 along the circumferential direction Dr of the shaft 441, and is disposed opposite the reference magnet 442R in the radial direction. The protrusion 4411 extends along the axial direction over the entire region of the reference magnet 442R from an end face 442e1 at one end to an end face 442e2 at the other end along the axial direction.

Furthermore, the protrusion 4411 protrudes radially outward toward the reference magnet 442R. Specifically, the protrusion 4411 is formed in the shape of a rectangular parallelepiped having a tip-end plane extending, along the axial direction Dx, parallel to a tangent line to the outer circumferential surface 441s of the shaft 441. That is, the protrusion 4411 has a configuration similar to, for example, a parallel key (machine key) formed on the outer circumferential surface 441s of the shaft 441. The protrusion 4411 is formed integrally with the shaft-form main body of the shaft 441.

The depression 4421 is formed in the inner circumferential surface of the reference magnet 442R and extends along the axial direction Dx of the shaft 441. Specifically, the depression 4421 is disposed in a middle part of the inner circumferential surface 442s1 of the reference magnet 442R along the circumferential direction Dr of the shaft 441, and is disposed opposite the shaft 441 in the radial direction. The depression 4421 extends along the axial direction over the entire region of the reference magnet 442R from an end face 442e1 at one end to an end face 442e2 at the other end along the axial direction.

Furthermore, the depression 4421 is depressed into the inside the reference magnet 442R radially. That is, the depression 4421 is depressed radially outward from the inner circumferential surface 442s1 of the reference magnet 442R toward the outer circumferential surface 442s2. Specifically, the depression 4421 is formed in the shape of a rectangular parallelepiped having an inner plane extending, along the axial direction Dx, parallel to a tangent line to the inner circumferential surface 442s1 of the reference magnet 442R.

The protrusion 4411 of the shaft 441 is inserted into the depression 4421. That is, the depression 4421 has a shape and size that can accommodate the protrusion 4411.

FIG. 8 is a sectional view showing a state in which a second magnet 442 is attached to the shaft 441 of the developing roller 44 in FIG. 7 and to the reference magnet 442R. As shown in FIG. 8, the second magnet 442 is fixed adjacent, along the circumferential direction Dr, to the reference magnet 442R, which is fixed via the depression 4421 at the reference point (protrusion 4411) along the circumferential direction Dr of the shaft 441. Similarly to the second magnet 442, a third and subsequent magnets 442, of which none is illustrated, are fixed one adjacent to another along the circumferential direction Dr of the shaft 441.

FIG. 9 is a sectional view of a shaft 441 and a reference magnet 442R of a developing roller 44 of Modified Example 1. Since the developing rollers 44 of the modified examples described below have a basic configuration similar to that of the developing roller 44 described earlier with reference to FIGS. 6 to 8, no overlapping description will be repeated.

In the developing roller 44 of Modified Example 1, the shaft 441 has a depression 4412. The reference magnet 442R has a protrusion 4422.

The depression 4412 is formed in the outer circumferential surface 441s of the shaft 441 and extends along the axial direction Dx of the shaft 441. The depression 4412 is depressed radially into the shaft 441. The protrusion 4422 of the reference magnet 442R is inserted into the depression 4412. That is, the depression 4412 has a shape and size that can accommodate the protrusion 4422.

The protrusion 4422 is formed on the inner circumferential surface 442s1 of the reference magnet 442R and extends along the axial direction Dx of the shaft 441. The protrusion 4422 protrudes radially toward the shaft 441. The protrusion 4422 is formed integrally with the shaft-form main body of the reference magnet 442R, which has a fan-shaped section.

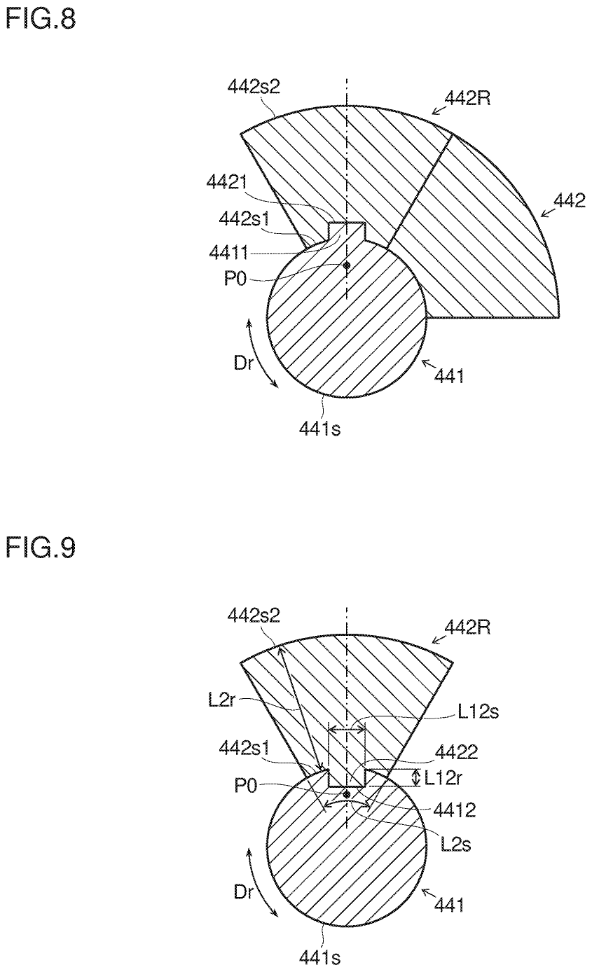

FIG. 10 is a sectional view of a shaft 441 and a reference magnet 442R of a developing roller 44 of Modified Example 2. In the developing roller 44 of Modified Example 2, the shaft 441 has a plurality (in this example, two) of protrusions 4413. The reference magnet 442R also has a plurality (in this example, two) of depressions 4423.

The two protrusions 4413 are formed on the outer circumferential surface 441s of the shaft 441, extend along the axial direction Dx of the shaft 441, and protrude radially outward toward the reference magnet 442R. The two protrusions 4413 extend parallel to the axial direction Dx and to each other and are disposed at a predetermined interval along the circumferential direction Dr.

The two depressions 4423 are formed in the inner circumferential surface 442s1 of the reference magnet 442R, extend along the axial direction Dx of the shaft 441, and are depressed radially into the reference magnet 442R. The two depressions 4423 extend parallel to the axial direction Dx and to each other and are disposed at a predetermined interval along the circumferential direction Dr. The two protrusions 4413 of the shaft 441 are inserted into the two depressions 4423, respectively.

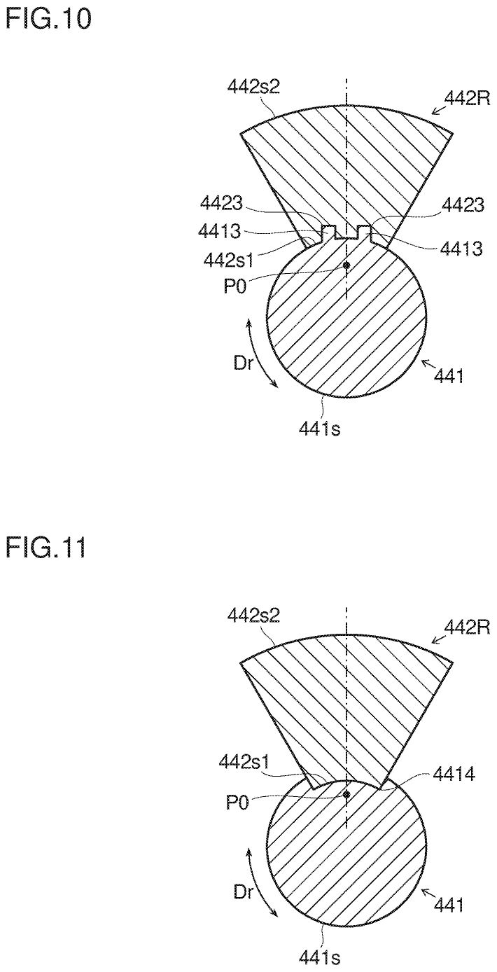

FIG. 11 is a sectional view of a shaft 441 and a reference magnet 442R of a developing roller 44 of Modified Example 3. In the developing roller 44 of Modified Example 3, the shaft 441 has a depression 4414, whereas the reference magnet 442R has no protrusion or depression on or in its inner circumferential surface 442s1.

The depression 4414 is formed on the outer circumferential surface 441s of the shaft 441, extends along the axial direction Dx of the shaft 441, and is depressed radially into the shaft 441. A part of the inner circumferential portion of the reference magnet 442R corresponding to the length of the depression 4414 along the radial direction is inserted into the depression 4414 over its entire region along the axial direction Dx and along the circumferential direction Dr.

Next, the magnetic characteristics of the reference magnet 442R according to practical examples will be described.

Table 1 lists data on magnetic characteristics in practical examples having the configuration shown in FIG. 7, in which the protrusion 4411 is formed on the shaft 441 and the depression 4421 is formed in the reference magnet 442R.

TABLE 1
Practical Examples

| | Shape of shaft protrusion | | | | | | |
|---|---|---|---|---|---|---|---|
| | Radial | Circumferential | | | | | |
| | length | length | Magnetic characteristics | | | | |
| | [mm] | [mm] | Rated | Rated | Rated | | |
| | Upper limit | Upper limit | magnetic | polar | half- | Pole angle | Deformation of |
| | value 1.66 | value 1.47 | force | angle | width | difference in | circumferential |
| | Lower limit | Lower limit | [mT] | [°] | [°] | axial | end face of |
| | value 1.00 | value 1.20 | 90 ± 5 | 0 ± 1 | 40 ± 3 | direction | magnet |
| 1 | 1.30 | 1.30 | 90.1 | 0.3 | 39.5 | 0.2 | No |
| 2 | 1.00 | 1.20 | 89.5 | 0.1 | 40.8 | 0.2 | No |
| 3 | 1.65 | 1.45 | 90.5 | 0.5 | 40.3 | 0.1 | No |

*Magnet size: radial length = 4.5 mm, inner circumferential length = 3.5 mm

Practical Examples 1, 2, and 3 each have different specifications for the size of the protrusions 4411. The reference magnet 442R has a rated magnetic force of 90±5 [mT], a rated polar angle of 0±1 [°], and a rated half-width of 40±3 [°]. “Polar angle difference in axial direction” denotes the deviation in polar angles at a plurality of points along the axial direction Dx, and means that as the polar angle difference increases, the twist (curvature) of the reference magnet 442R along the axial direction Dx increases. The twist (curvature) of the reference magnet 442R along the axial direction Dx is, with respect to the reference point P0 along the circumferential direction Dr of the shaft 441, the deviation (displacement), relative to the circumferential position of the end face 442e1 of the reference magnet 442R at one end along the axial direction Dx, of the circumferential position of its end face 442e2 at the other end. “Deformation of circumferential end face of magnet” denotes the presence or absence of deformation in the end faces of the reference magnet 442R that are located at its opposite ends along the circumferential direction Dr and that extend along the axial direction Dx and the radial direction.

According to Table 1, Practical Examples 1, 2, and 3 are each within the ranges of the rated magnetic force, the rated polar range, and the rated half-width. And, in each of Practical Examples 1, 2, and 3, the polar angle difference in the axial direction is small, and there is no deformation in the circumferential end face of the magnet. That is, each of Practical Examples 1, 2, and 3, in which the protrusion 4411 is formed on the shaft 441, had improved positioning accuracy of the reference magnet 442R, (i.e., a small polar angle difference in the axial direction (twist)), thereby achieving suitable magnetic characteristics.

Based on the results of Table 1, it is preferable that the radial length L11r (see FIG. 7) of the protrusion 4411 of the shaft 441 have a lower limit value of 1.00 [mm] and an upper limit value of 1.66 [mm]. In other words, considering that the radial length L2r (see FIG. 7) of the reference magnet 442R is 4.5 [mm], it is preferable that the radial length L11r of the protrusion 4411 formed on the shaft 441 have a lower limit value of 1.0 [mm] and an upper limit value of 37% of the radial length L2r of the reference magnet 442R.

It is also preferable that the circumferential length L11s (see FIG. 7) of the protrusion 4411 of the shaft 441 have a lower limit value of 1.20 [mm] and an upper limit value of 1.47 [mm]. In other words, considering that the circumferential length L2s (see FIG. 7) of the inner circumferential surface of the reference magnet 442R is 3.5 [mm], it is preferable that the circumferential length L11s of the protrusion 4411 formed on the shaft 441 have a lower limit value of 1.2 [mm] and an upper limit value of 42% of the circumferential length L2s of the inner circumferential surface of the reference magnet 442R.

Table 2 lists data on magnetic characteristics in practical examples having the configuration shown in FIG. 9, in which the depression 4412 is formed in the shaft 441 and the protrusion 4422 is formed on the reference magnet 442R.

TABLE 2
Practical Examples

| | Shape of shaft depression | | | | | | |
|---|---|---|---|---|---|---|---|
| | Radial | Circumferential | | | | | |
| | length | length | Magnetic characteristics | | | | |
| | [mm] | [mm] | Rated | Rated | Rated | | |
| | Upper limit | Upper limit | magnetic | polar | half- | Pole angle | Deformation of |
| | value 2.00 | value 3.54 | force | angle | width | difference in | circumferential |
| | Lower limit | Lower limit | [mT] | [°] | [°] | axial | end face of |
| | value 0.50 | value 1.00 | 90 ± 5 | 0 ± 1 | 40 ± 3 | direction | magnet |
| 4 | 1.00 | 1.50 | 89.8 | 0.8 | 40.5 | 0.3 | No |
| 5 | 0.50 | 1.00 | 90.2 | 0.3 | 39.3 | 0.5 | No |
| 6 | 2.00 | 3.53 | 90.6 | 1.0 | 40.1 | 0.2 | No |

*Magnet size: radial length = 4.5 mm, inner circumferential length = 3.5 mm

Examples 4, 5, and 6 each have different specifications for the size of the depressions 4412. The reference magnet 442R has a rated magnetic force, a rated polar angle, and a rated half-width similar to those in Table 1.

According to Table 2, Practical Examples 4, 5, and 6 are each within the ranges of the rated magnetic force, the rated polar range, and the rated half-width. And, in each of Practical Examples 4, 5, and 6, the polar angle difference in the axial direction is small, and there is no deformation in the circumferential end face of the magnet. That is, each of Practical Examples 4, 5, and 6, in which the depression 4412 is formed in the shaft 441, had improved the positioning accuracy of the reference magnet 442R, (i.e., a small polar angle difference in the axial direction (twist)), thereby achieving suitable magnetic characteristics.

Based on the results of Table 2, it is preferable that the radial length L12r (see FIG. 9) of the depression 4412 formed in the shaft 441 have a lower limit value of 0.50 [mm] and an upper limit value of 2.00 [mm].

It is also preferable that the circumferential length L12s of the depression 4412 of the shaft 441 have a lower limit value of 1.00 [mm] and an upper limit value of 3.54 [mm]. In other words, considering that the circumferential length L2s of the inner circumferential surface of the reference magnet 442R is 3.5 [mm], it is preferable that the circumferential length L12s of the depression 4412 formed in the shaft 441 have a lower limit value of 1.0 [mm] and an upper limit value 101% of the circumferential length L2s of the inner circumferential surface of the reference magnet 442R.

With the above configuration, with reference to the protrusions 4411 and 4422 and the depressions 4412 and 4421 extending along the axial direction Dx of the shaft 441, the reference magnet 442R can be fixed to the outer circumferential surface 441s of the shaft 441. This helps prevent curvature of the reference magnet (magnetic pole) 442R along the axial direction Dx of the developing roller 44. This makes it possible to prevent deviation in the magnetic angle of the developing roller 44. As a result, the developing roller 44 has improved positioning accuracy of the magnet 442, thereby achieving suitable magnetic characteristics.

For comparison with the practical examples described above, the magnetic characteristics of the reference magnet 442R in the comparative example will be described.

Table 3 lists data on magnetic characteristics in the comparative example with the configuration shown in FIG. 7, in which the protrusion 4411 is formed on the shaft 441 and the depression 4421 is formed in the reference magnet 442R.

TABLE 3
Comparative Examples

| | Shape of shaft protrusion | | | | | | |
|---|---|---|---|---|---|---|---|
| | Radial | Circumferential | | | | | |
| | length | length | Magnetic characteristics | | | | |
| | [mm] | [mm] | Rated | Rated | Rated | | |
| | Upper limit | Upper limit | magnetic | polar | half- | Pole angle | Deformation of |
| | value 1.66 | value 1.47 | force | angle | width | difference in | circumferential |
| | Lower limit | Lower limit | [mT] | [°] | [°] | axial | end face of |
| | value 1.00 | value 1.20 | 90 ± 5 | 0 ± 1 | 40 ± 3 | direction | magnet |
| 1 | 0.40 | 1.30 | 95.1 | 0.3 | 39.5 | 1.3 | No |
| 2 | 2.50 | 1.30 | 82.5 | 0.1 | 39.8 | 0.2 | No |
| 3 | 1.00 | 2.00 | 90.2 | 0.9 | 40.8 | 1.5 | Yes |

*Magnet size: radial length = 4.5 mm, inner circumferential length = 3.5 mm

Comparative Examples 1, 2, and 3 each have different specifications for the size of the protrusions 4411. The reference magnet 442R has a rated magnetic force, a rated polar angle, and a rated half-width similar to those in Tables 1 and 2.

According to Table 3, Comparative Example 1 is outside the range of the radial length of the protrusion 4411 determined based on Practical Examples 1, 2, and 3, is out of the rated magnetic force, and has a polar angle difference in the axial direction as large as 1.3. Comparative Example 2 is outside the range of the radial length of the protrusion 4411 determined based on Practical Examples 1, 2, and 3 and is out of the rated magnetic force. Comparative Example 3 is outside the range of the circumferential length of the protrusion 4411 determined based on Practical Examples 1, 2, and 3, has a polar angle difference in the axial direction as large as 1.5, and exhibits deformation of the circumferential end face of the magnet.

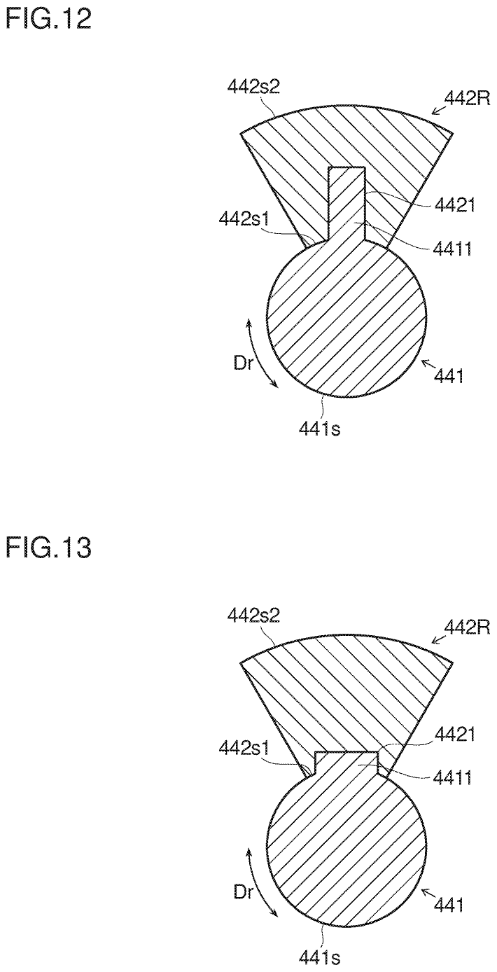

FIGS. 12 and 13 are sectional views of shafts 441 and reference magnets 442R of developing rollers 44 of Comparative Examples 2 and 3.

In the case of Comparative Example 2 shown in FIG. 12, the radial length of the protrusion 4411 formed on the shaft 441 exceeds 37% of the redial length of the reference magnet 442R. Accordingly, the reference magnet 442R has a smaller radial length radially outward of the protrusion 4411 and has a reduced magnetic force. On the other hand, if, as in Comparative Example 1, the protrusion 4411 has a radial length less than 1.00 [mm], the depression 4421 of the reference magnet 442R does not easily fit into the protrusion 4411 and easily comes off the shaft 441; this makes the reference magnet 442R more likely to be twisted.

In the case of Comparative Example 3 shown in FIG. 13, the circumferential length of the protrusion 4411 formed on the shaft 441 exceeds 42% of the circumferential length of the inner circumferential surface of the reference magnet 442R. Accordingly, the reference magnet 442R has a shorter circumferential length circumferentially outward of the protrusion 4411 and exhibits deformation of the circumferential end face of the magnet. If the protrusion 4411 has a circumferential length less than 1.2 [mm], it extends radially to be elongate and this reduces the ease of attaching the reference magnet 442R to the shaft 441.

That is, in each of Comparative Examples 1, 2, and 3, the reference magnet 442R has reduced positioning accuracy (i.e., a large polar angle difference in the axial direction (twist)), and thus suitable magnetic characteristics cannot be obtained.

Table 4 lists data on magnetic characteristics in the comparative example with the configuration shown in FIG. 9, in which the depression 4412 is formed in the shaft 441 and the protrusion 4422 is formed on the reference magnet 442R.

TABLE 4
Comparative Examples

| | Shape of shaft depression | | | | | | |
|---|---|---|---|---|---|---|---|
| | Radial | Circumferential | | | | | |
| | length | length | Magnetic characteristics | | | | |
| | [mm] | [mm] | Rated | Rated | Rated | | |
| | Upper limit | Upper limit | magnetic | polar | half- | Pole angle | Deformation of |
| | value 2.00 | value 3.54 | force | angle | width | difference in | circumferential |
| | Lower limit | Lower limit | [mT] | [°] | [°] | axial | end face of |
| | value 0.50 | value 1.00 | 90 ± 5 | 0 ± 1 | 40 ± 3 | direction | magnet |
| 4 | 0.00 | 0.00 | 90.3 | 1.2 | 39.9 | 1.5 | No |
| 5 | 2.00 | 0.50 | 99.1 | 0.8 | 39.5 | 1.8 | No |
| 6 | 3.00 | 1.50 | 98.6 | 0.5 | 40.5 | 1.2 | No |

*Magnet size: radial length = 4.5 mm, inner circumferential length = 3.5 mm

Comparative Examples 4, 5, and 6 each have different specifications for the size of the depressions 4412. The reference magnet 442R has a rated magnetic force, a rated polar angle, and a rated half-width similar to those in Tables 1 and 2.

According to Table 4, Comparative Example 4 is outside the range of the radial and circumferential lengths of the depressions 4412 determined based on Practical Examples 4, 5, and 6, is out of the rated polar angle, and has a polar angle difference in the axial direction as large as 1.5. Comparative Example 5 is outside the range of the circumferential length of the depressions 4412 determined based on Practical Examples 4, 5, and 6, is out of the rated magnetic force, and has a polar angle difference in the axial direction as large as 1.8. Comparative Example 6 is outside the range of the radial length of the depressions 4412 determined based on Practical Examples 4, 5, and 6, is out of the rated magnetic force, and has a polar angle difference in the axial direction as large as 1.2.

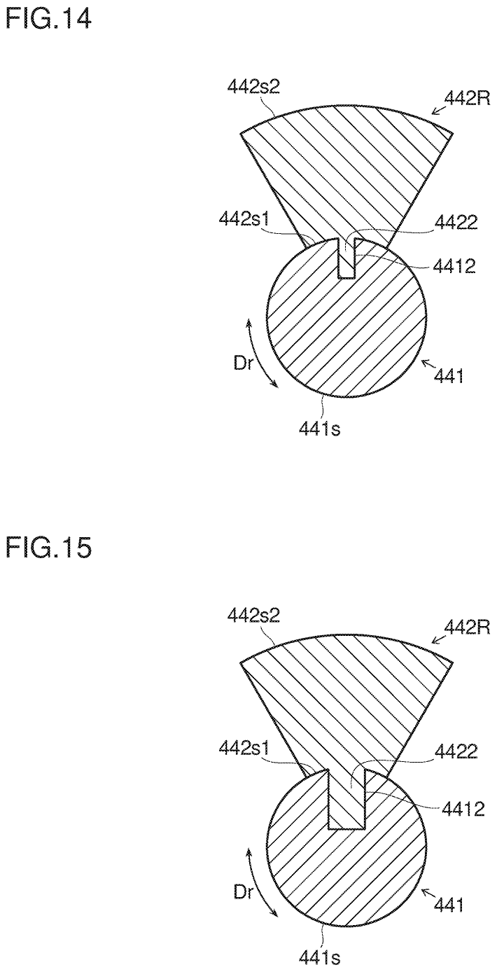

FIGS. 14 and 15 are sectional views of shafts 441 and reference magnets 442R of developing rollers 44 of Comparative Examples 5 and 6.

In the case of Comparative Example 5 shown in FIG. 14, the circumferential length of the depression 4412 formed in the shaft 441 is shorter than the lower limit value of 1.00 [mm]. Accordingly, the protrusion 4422 of the reference magnet 442R extends radially to be thin, is not easily inserted into the depression 4412 and easily comes off the shaft 441; this makes the reference magnet 442R more likely to be twisted and reduces its magnetic force. If the circumferential length of the depression 4412 exceeds 101% of the circumferential length of the inner circumferential surface of the reference magnet 442R, a gap is formed between the depression 4412 and the protrusion 4422 and this makes the reference magnet 442R more likely to be twisted.

In the case of Comparative Example 6 shown in FIG. 15, the radial length of the depression 4412 formed in the shaft 441 exceeds the upper limit value of 2.00 [mm]. Accordingly, the protrusion 4422 of the reference magnet 442R does not easily fit into the depression 4412 and easily comes off the shaft 441; this makes the reference magnet 442R more likely to be twisted. Likewise, if the radial length of the depression 4412 is less than the lower limit value of 0.50 [mm], the protrusion 4422 of the reference magnet 442R does not easily fit into the depression 4412 and easily comes off the shaft 441; this makes the reference magnet 442R more likely to be twisted.

That is, in each of Comparative Examples 4, 5, and 6, the reference magnet 442R has reduced positioning accuracy (i.e., a large polar angle difference in the axial direction (twist)), and thus suitable magnetic characteristics cannot be obtained.

The magnet 442 is configured to contain magnetic powder blended with, for example, chlorinated polyethylene (CPE), polyolefin elastomer (POE), and other resin materials. Furthermore, the magnetic powder in the magnet 442 is ferrite and this makes it possible to obtain suitable magnetic characteristics by use of common magnetic powder.

The magnetic powder in the magnet 442 may contain, in addition to ferrite, rare earth magnetic powder. The rare earth magnetic powder is, for example, magnetic powder of a material such as neodymium or samarium. This configuration helps increase the magnetic force of the magnet 442. This allows the image forming apparatus 1 to achieve high-quality image formation.

While one embodiment of the present disclosure has been described above, it is not meant to limit the scope of the present disclosure.

For example, while the embodiment described above deals with an example where the image forming apparatus 1 is what is called a tandem-type image forming apparatus for color printing that forms images of a plurality of colors so as to superimpose them on each other, this is not meant as any limitation to such models. The image forming apparatus may be a non-tandem-type image forming apparatus for color printing or an image forming apparatus for monochrome printing.

What is claimed is:

1. A developing roller comprising:
a shaft;
a plurality of magnets fixed to an outer circumferential surface of the shaft to extend along an axial direction of the shaft; and
a developing sleeve disposed to face a radially outer side of the magnet across a predetermined gap,
wherein
the plurality of the magnets include a reference magnet that is fixed first at a reference point along a circumferential direction of the shaft, and
the developing roller has:
a protrusion formed on one of the outer circumferential surface of the shaft and an inner circumferential surface of the reference magnet, the protrusion extending along the axial direction and protruding radially toward the other of the outer circumferential surface of the shaft and the inner circumferential surface of the reference magnet; and
a depression formed in the other of the outer circumferential surface of the shaft and the inner circumferential surface of the reference magnet, the depression extending along the axial direction and being depressed radially into the other of the outer circumferential surface of the shaft and the inner circumferential surface of the reference magnet, the protrusion being inserted in the depression.

2. The developing roller according to claim 1, wherein
a radial length of the protrusion formed on the shaft has a lower limit value of 1.00 [mm] and an upper limit value of 37% of a radial length of the reference magnet, and
a circumferential length of the protrusion formed on the shaft has a lower limit value of 1.2 [mm] and an upper limit value of 42% of the circumferential length of the inner circumferential surface of the reference magnet.

3. The developing roller according to claim 1, wherein
a radial length of the depression formed in the shaft has a lower limit value of 0.5 [mm] and an upper limit value of 2.0 [mm], and
a circumferential length of the depression formed in the shaft has a lower limit value of 1.0 [mm] and an upper limit value of 101% of the circumferential length of the inner circumferential surface of the reference magnet.

4. The developing roller according to claim 1, wherein
the magnet is configured to contain magnetic powder, and
the magnetic powder in the magnet is ferrite.

5. The developing roller according to claim 4, wherein
the magnetic powder in the magnet contains rare earth magnetic powder.

6. A developing device comprising:
a developing container that stores toner to be fed to an image marrying member; and
the developing roller according to claim 1 rotatably supported on the developing container to face the image carrying member, the developing roller feeding the toner in the developing container to the image carrying member.

7. An image forming apparatus including the developing device according to claim 6.
